(19) United States
(12) Patent Application Publication
(10) Pub. No.: US 2024/0175731 A1
(43) Pub. Date: May 30, 2024

(54) Enclosure and heating, ventilation and air conditioning system comprising the enclosure

(71) Applicant: Danfoss A/S, Nordborg (DK)

(72) Inventor: Wayne Edgar Alphonso, Nordborg (DK)

(21) Appl. No.: 18/515,644

(22) Filed: Nov. 21, 2023

(30) Foreign Application Priority Data
Nov. 25, 2022 (DE) 202022106612.4

(51) Int. Cl. G01D 11/24; F24F 11/36

(52) U.S. Cl. CPC G01D 11/245; F24F 11/36

(57) ABSTRACT

An enclosure for a refrigerant gas leak sensor for a heating, ventilation and air conditioning system includes a bottom part (12) for mounting the enclosure (10) on a mounting surface and a top part (14) being attached to the bottom part (12). The bottom part (12) and the top part (14) enclose a chamber (16) for receiving a printed circuit board having a sensing element of the refrigerant gas leak sensor. The bottom part (12) has a channel (18) for connecting to the sensing element and is in fluid communication with ambient air, wherein the enclosure (10) has an exterior sidewall (20) extending in a circular manner around the chamber (16) and the channel (18) and extending between the bottom part (12) and the top part (14).

### CROSS-REFERENCE TO RELATED APPLICATION

This application claims foreign priority benefits under 35 U.S.C. § 119 from German Patent Application No. 202022106612.4, filed Nov. 25, 2022, the content of which is hereby incorporated by reference in its entirety.

### TECHNICAL FIELD

The invention relates to an enclosure and a heating, ventilation and air conditioning system comprising the enclosure.

### BACKGROUND

Gas detection sensors are used in a heating, ventilation and air conditioning system (HVAC) unit both for commercial and residential use. The gas sensor detects leakage of refrigerant gas in the air conditioning unit and sends a signal to a control unit for mitigation. The gas detection sensor is a safety device, which may be installed in HVAC units to detect the leakage of refrigerant gases that have a low to high flammability and toxicity.

The gas detection sensor may comprise an enclosure and a sensing element. The enclosure protects the sensing element from moisture, refrigerant oils, mechanical forces, UV light, corrosion, particles, and harsh thermal conditions. The enclosure may comply with IEC 60529 Ingress Protection Code moreover it may comply with IP 54.

A refrigerant gas leak sensor for a HVAC system is known, the sensor including a rectangular housing, a gas sensor core element and mounting means. The housing has primary walls delimiting an inner volume. The gas sensor core element is arranged in the inner volume. The mounting means is configured to attach the housing to a mounting surface, wherein a first surface of a primary wall of the housing faces the mounting surface and wherein a gap is provided between the first surface and the mounting surface. An opening is formed in the housing for exposing the gas sensor core element to gases within the HVAC system, wherein the opening is provided on the first surface. The refrigerant gas leak sensor may be provided as part of an air handling unit.

Thus, there is a need to provide an enclosure enhancing the performance of the sensor.

### SUMMARY

Claims 1 and 16 indicate the main features of the invention. Features of embodiments of the invention are subject of claims 2 to 15.

In an aspect of the invention, an enclosure for a refrigerant gas leak sensor for a heating, ventilation and air conditioning system is provided, the enclosure comprising a bottom part for mounting the enclosure on a mounting surface and a top part being attached to the bottom part, the bottom part and the top part enclosing a chamber for receiving a printed circuit board having a sensing element of the refrigerant gas leak sensor and preferably electronics to convert gas leak sensor signal to analogue or digital signal, the bottom part having a channel for connecting to the sensing element and being in fluid communication with ambient air, characterized in that the enclosure has an exterior sidewall extending in a circular manner around the chamber and the channel and extending between the bottom part and the top part.

Due to the exterior sidewall extending in a circular manner, the enclosure has a circular shape. The external sidewall may extend around a longitudinal axis extending between the bottom part and the top part through the chamber. The channel may for example extend along a portion of the longitudinal axis. Furthermore, the channel may have a shape corresponding to the shape of the sensing element of the refrigerant gas leak sensor. The channel may start at the chamber, wherein the opening of the channel being arranged at the chamber may be configured to receive a sensing element of the refrigerant gas leak sensor. Placing the sensing element on the opening of the channel may close that opening and interrupt a fluid communication between the channel and the chamber. The enclosure may have a cylindrical shape, wherein the external sidewall may provide the lateral area of the cylinder. The bottom part and the top part may comprise substantially circular areas that may form the base areas of the cylinder. By having such a shape, the enclosure provides a low drag and a better aerodynamic characteristic for the enclosed sensor compared to a rectangular shape of enclosures, which is commonly used. The thermal performance and affinity to humidity causing failures are reduced since no cold spots form out and due to a uniform heating and easy drainage of condensate.

The gas sensor with enclosure may be mounted in any advantageous orientation, e.g. vertically, horizontally or inclined and is not limited to standing or hanging installation.

According to an example, the exterior sidewall may have a first section being attached to the bottom part and a second section being attached to the top part.

Thus, the exterior sidewall is formed when the first section at the bottom part and the second section at the top part are connected to each other. This provides an easy formation of the exterior sidewall of the enclosure.

According to another example, a connection between the exterior sidewall and the top part may be rounded.

This further reduces the drag of the enclosure, further improving the aerodynamic characteristic of the enclosed sensor.

According to a further example, the exterior sidewall may comprise at least one skirt having at least one opening being in fluid communication to the channel.

The skirt may extend around the circumference of the enclosure along the exterior sidewall. The direction of the circumference defines a circumferential direction of the enclosure.

Further, the skirt may for example be attached to the exterior sidewall and extend at least partially on the outer side of the exterior sidewall. Particularly, the skirt may for example be attached to the second section of the exterior sidewall. Furthermore, the skirt may for example have a tapering shape in view along the longitudinal axis. The skirt may reduce the drag and improve the aerodynamic characteristic of the enclosed sensor, further. Due to the opening, the skirt is porous. By having such a porous feature along the circumference of the sensor, the protection of the sensing element against oil, particles and insects or animals is improved.

The skirt may be extended to a mounting plane of the enclosure, the mounting plane defining the position of the mounting surface when the enclosure is mounted. Thus, the side skirt supports the enclosure while mounting it. This provides mechanical stability while mounting the enclosure with the sensor as the skirt flushes with the mounting points.

For example, the skirt may comprise at least one opening that, in a mounted state of the enclosure, is an access opening to a diffusion dominated gas flow path passing the channel outside the bottom part.

The at least two openings may act as entrance and exit of the gas flow path. The gas flow path is diffusion dominated which reduces turbulences and provides a controlled gas flow to the sensing element via the channel. Thus, the skirt may transform the convection dominated gas flow from outside of the enclosure to the diffusion dominated gas flow providing higher reliability. Furthermore, it may reduce the variability in the performance.

According to an example, the channel may be arranged in the center of the bottom part.

The channel may be arranged in the center of the circular shape of the bottom part.

Furthermore, the enclosure may for example comprise a snap-fit assembly attaching the bottom part and the top part.

Using a snap fit assembly to attach the bottom part and the top part provides a quick and simples assembly mechanism for the enclosure and the refrigerant gas leak sensor. The snap fits may reduce the assembly time and effort since no additional steps in standard operating procedures, as torque requirements for screwing etc. are required. This may also reduce the inventory cost and the need for additional assembly equipment.

In an example, the snap-fit assembly may comprise at least one snap-fit attached to the bottom part.

The top part may comprise receptions for the snap-fits in which the snap-fits of the bottom part may snap in for assembly.

In another example, the snap-fit assembly may comprise at least one snap-fit attached to the top part.

In that example, the bottom part may comprise receptions for the snap-fits in which the snap-fits of the top part may snap in for assembly.

In a further example, both the top part and the bottom part may comprise snap-fits. Then, both the top part and the bottom part may comprise receptions for the corresponding snap-fits of the other part.

The at least one snap-fit may for example project from the sidewall towards the top part.

The at least one snap-fit may extend along the direction of the longitudinal axis. Furthermore, the snap-fit may be bendable in a transverse direction to the direction of the longitudinal axis. Thus, when assembling the top part and the bottom part, the top part and the bottom part may be moved along the longitudinal direction while the snap-fit bends into the chamber in a direction transverse to the longitudinal direction before snapping in to the respective reception.

If the snap-fit is arranged on the top part, then the snap-fit may project from the sidewall towards the bottom part.

The snap-fit may project from the first or second section of the exterior sidewall.

According to an example, the bottom part may comprise at least one mounting leg having an elongated mounting hole.

The elongated mounting hole provides a flexible mounting position on the mounting surface. For mounting the enclosure with the refrigerant gas leak sensor to the HVAC unit, the elongated mounting hole provides high tolerances for the user to mount the enclosure with the sensor. This may increase the productivity and/or the assembly speed.

In another example, the enclosure may comprise a connector opening for leading through an electrical connector being attachable to a printed circuit board arranged in the chamber.

Furthermore, an electrical connector may for example be arranged in the connector opening.

The electrical connector may be attachable to a printed circuit board assembly. For example, the electrical connector may be soldered to the printed circuit board assembly. Furthermore, the electrical connector may be electrically connected to the printed circuit board assembly and to the sensing element mounted on the printed circuit board assembly.

According to an example, the electrical connector may comprise 1 to 10 pins, preferably 2 to 8 pins; further preferably 3 to 7 pins, most preferred 4 to 6 pins.

The electrical connector may for example be a cap or socket of a mate and lock connector.

For example, the exterior sidewall may comprise the connector opening.

The exterior sidewall may be interrupted at the position of the connector opening. For example, the exterior sidewall may be interrupted in a circumferential direction. The electrical connector may then extend through the connector opening and through the exterior sidewall. Furthermore, the electrical connector may then extend from the chamber to the outside of the enclosure.

In another example, at least the top part and/or the bottom part may comprise a UV-resistant material, preferably a UV resistant polymer, a metal-coated polymer, a metal or a ceramic material.

Furthermore, the enclosure may for example comprise a printed circuit board assembly with a sensing element of a refrigerant gas leak sensor, the printed circuit board assembly being mounted in the chamber and the sensing element of the refrigerant gas leak sensor being arranged on the channel and closing the channel.

In a second aspect, a refrigerant gas leak sensor is provided, the refrigerant gas leak sensor having a printed circuit board assembly, a sensing element, and an enclosure as described above, wherein the printed circuit board assembly is arranged in the chamber and wherein the sensing element is attached to the printed circuit board assembly and the sensing element is arranged on an entrance of the channel.

The effects and further embodiments of the refrigerant gas leak sensor according to the present invention are analogous to the effects and embodiments of the enclosure according to the description mentioned above. Thus, it is referred to the above description of the enclosure.

In another aspect, a heating, ventilation and air conditioning system is provided, the system comprising at least one mounting surface and at least one enclosure according to the description above having a printed circuit board assembly with a refrigerant gas leak sensor, wherein the enclosure is mounted on the mounting surface.

The effects and further embodiments of the heating, ventilation and air conditioning system according to the present invention are analogous to the effects and embodiments of the enclosure according to the description mentioned above. Thus, it is referred to the above description of the enclosure.

### BRIEF DESCRIPTION OF THE DRAWINGS

Further features, details and advantages of the invention result from the wording of the claims as well as from the following description of exemplary embodiments based on the drawings. The figures show:

FIG. 1 a schematic drawing of the refrigerant gas leak sensor;

FIG. 2 a schematic bottom view of the refrigerant gas leak sensor;

FIG. 3 a schematic drawing of the refrigerant gas leak sensor showing the mounting leg;

FIG. 4 a further schematic drawing of the refrigerant gas leak sensor;

FIG. 5 a schematic top view of the refrigerant gas leak sensor;

FIG. 6 a schematic view on the electrical connector and the exterior sidewall;

FIG. 7 a schematic view on another example of the electrical connector;

FIG. 8 a schematic view on a further example of the electrical connector;

FIG. 9 a schematic drawing of the enclosure;

FIG. 10 a schematic drawing of the enclosure with a printed circuit board assembly;

FIG. 11 another view of the schematic drawing of the enclosure of FIG. 10; and

FIG. 12 another view of the schematic drawing of the enclosure of FIGS. 10 and 11.

### DETAILED DESCRIPTION

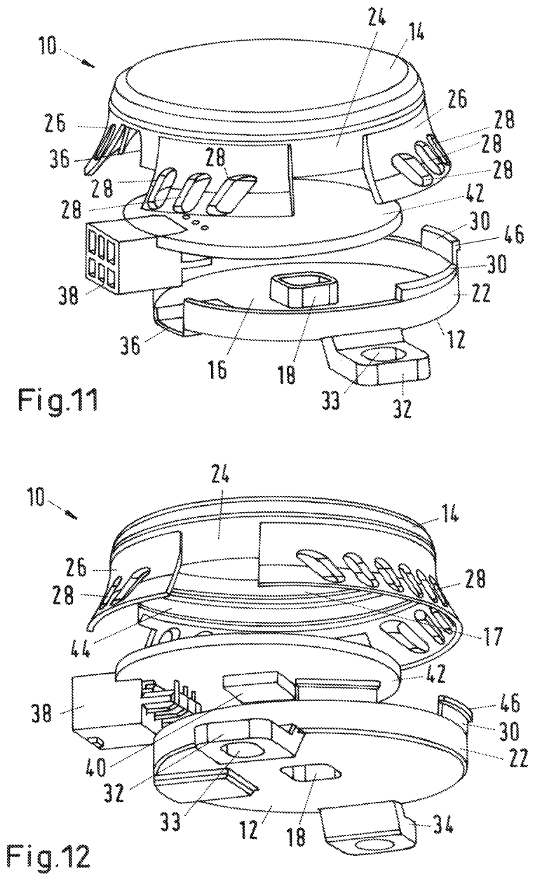

FIG. 1 shows a refrigerant gas leak sensor comprising an enclosure 10. The enclosure 10 comprises a bottom part 12 and a top part 14 enclosing a chamber 16, 17 as shown in FIG. 10 and FIG. 11, in which a printed circuit board assembly with a sensing element is arranged. One chamber part 16 of the chamber is arranged in the bottom part 12. Another chamber part 17 of the chamber is arranged in the top part 14. The top part 14 is attached to the bottom part 12 which combines the chamber parts 16, 17 to the complete chamber. The top part 14 and/or the bottom part 12 may comprise a UV-resistant material, preferably a UV resistant polymer, a metal-coated polymer, a metal or a ceramic material.

The refrigerant gas leak sensor further comprises an electrical connector 38 being electrically attached to the printed circuit board assembly and projecting through the enclosure 10.

The bottom part 12 is configured to be mounted on a mounting surface. The bottom part 12 may comprise a mounting leg assembly with a first mounting leg 32 and a second mounting leg 34. At least one of the mounting legs 32, 34 may comprise an elongated mounting hole 33. In this example, the first mounting leg 32 comprises the elongated mounting hole 33. The second mounting leg 34 may comprise a round mounting hole. Using the elongated mounting hole 33, the tolerances for mounting the refrigerant gas leak sensor are increased.

The mounting leg assembly is configured such that the bottom part 12 is spaced apart to the mounting surface. That means, if the mounting surface is flat and when the refrigerant gas leak sensor is mounted on the mounting surface, a free space is arranged between the bottom part 12 and the mounting surface.

Furthermore, the enclosure 10 comprises an exterior sidewall 20 extending around the chamber of the enclosure 10. The exterior sidewall 20 has a circular shape, i.e. the exterior sidewall 20 extend around the chamber in a circular manner. The exterior sidewall 20 is arranged between the bottom part 12 and the top part 14.

Furthermore, the exterior sidewall 20 may comprise a first section 22 and a second section 24. The first section 22 may be attached to the bottom part 12. The second section 24 may be attached to the top part 14. Both, the first section 22 and the second section 24 may extend in a circular manner around the chamber of the enclosure 10.

When attaching the bottom part 12 to the top part 14, the first section 22 and the second section 24 form the exterior sidewall 20.

The connection between the exterior sidewall 20 and the top part 14 may be rounded. Thus, the top part 14 does not have a sharp edge at the connection to the exterior sidewall 20.

The exterior sidewall 20 may comprise a skirt 26 extending around the exterior sidewall 20. The skirt 26 may have a tapering shape that extends around the chamber and the exterior sidewall 20. At the top part 14, a first diameter of the skirt 26 may be smaller than a second diameter of the skirt 26 at the bottom part 12.

A gap 29 may be arranged between the skirt 26 and the exterior sidewall 20. The gap 29 may extend annularly around the exterior sidewall 20. The gap 29 may be in fluid communication with the free space below the bottom part 12.

The skirt 26 may comprise at least one opening 28 in fluid communication with the gap 29 and the free space below the bottom part. In this example, the skirt 26 comprises a plurality of openings 28.

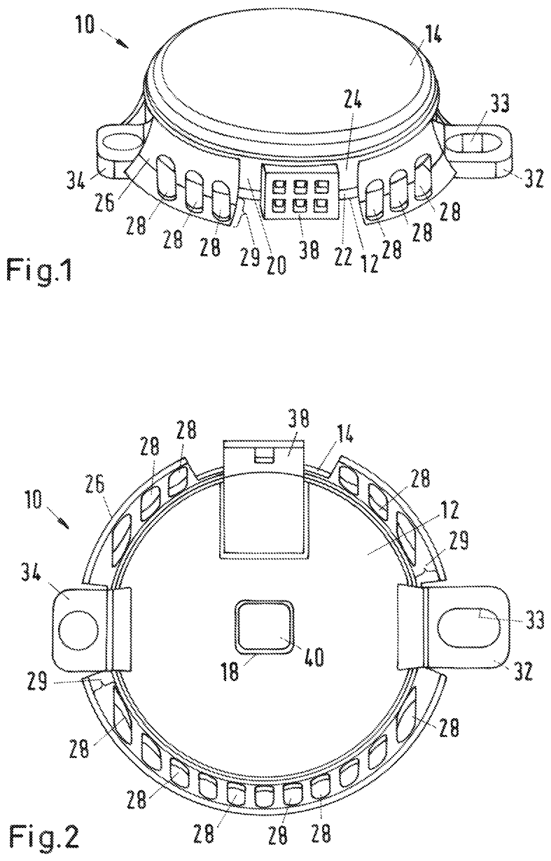

FIG. 2 shows a bottom view on the refrigerant gas lead sensor. The bottom part 12 has a circular outer surface facing the mounting surface in the mounted state of the sensor. Furthermore, the bottom part 12 comprises a channel 18 extending through the bottom part 12. The channel 18 extends between the chamber in the enclosure 10 and the free space below the bottom part 12. The channel 18 may be in fluid communication with the free space below the bottom part 12.

Furthermore, the channel 18 may be arranged in the center of the circular outer surface of the bottom part 12.

The sensing element 40 being arranged in the chamber and being attached to the printed circuit board assembly may be arranged on the opening of the channel 18 in the chamber. Thus, the sensing element 40 may close the channel 18 such that the channel 18 and the chamber are not in fluid communication. Only the sensing element 40 is in fluid communication with the channel 18.

The openings 28 may be distributed around the circumference of the skirt 26. The shape of the openings 28 may be such that a gas flow is guided in one direction. Thus, it is not required that the passages through the skirt 26 following up the openings 28 are oriented towards the channel 18. Contrary, the passages following up the openings 18 may be aligned in parallel to each other.

The openings 28 and the orientation of the openings 28 may transfer a convection dominated gas flow path outside the skirt 26 to a diffusion dominated gas flow path in the gap 29, the free space below the bottom part 12, and the channel 18.

The mounting legs 32, 34 may be aligned in a transverse manner to the orientation of the passages. Furthermore, the electrical connector 38 may be aligned in parallel to the passage. The alignment of the mounting legs 32, 34 and the electrical connector 38 may improve a gas flow in the free space below the bottom part 12.

The distance between the tips of the mounting legs 32, 34 may be in the range of 40 mm to 120 mm, preferably 60 mm to 100 mm, further preferably 70 mm to 90 mm, most preferred 80 mm.

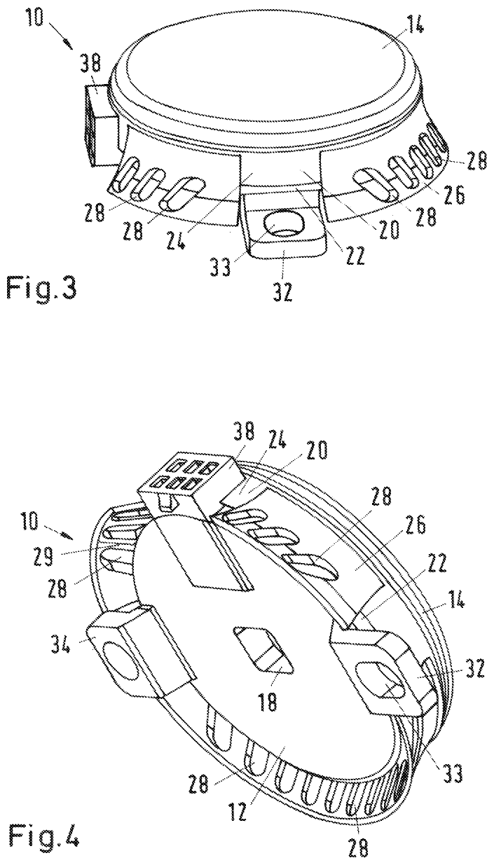

FIG. 3 shows another view of the enclosure 10 of the refrigerant gas leak sensor, which shows the orientation of the passages following up the openings 28. In this view, the passages are aligned in a horizontal direction. Thus, a gas flow path through the skirt 26 will flow in a horizontal direction into the free space below the bottom part 12.

FIG. 4 shows a tilted bottom view of the enclosure 10 of the refrigerant gas leak sensor. Step elements connect the mounting legs 32, 34 to the bottom part 12 such that the mounting legs 32, 34 lift the bottom surface of the bottom part 12 from the mounting surface, when the mounting legs 32, 34 are mounted to the mounting surface.

The skirt 26 may comprise a recess or a gap at the position of the mounting legs 32, 34 such that the mounting legs 32, 34 may project from the bottom part 12 through the skirt 26. Along a circumferential direction, the skirt 26 may be interrupted at the position of the mounting legs 32, 34.

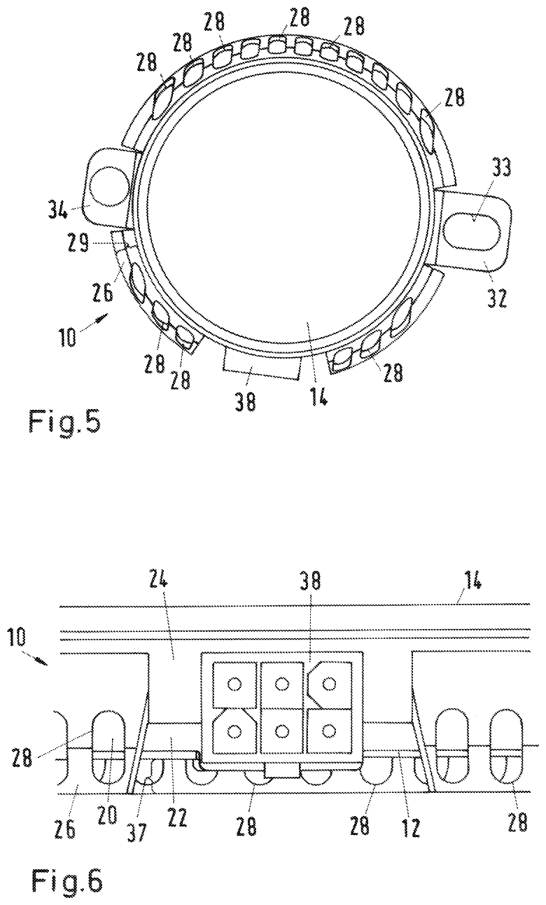

FIG. 5 shows a top view of the refrigerant gas leak sensor with a view on the top part 14 of the enclosure 10. The top part 14 comprises a circular outer surface. Due to the rounded connection between the top part 14 and the exterior sidewall, the enclosure 10 of the refrigerant gas leak sensor has an advantageous aerodynamic characteristic.

FIG. 6 shows a detailed view on an example of the electrical connector 38. In this example, the electrical connector 38 may be a mate and lock connector comprising six pins. The skirt 26 may comprise a recess or gap at the position of the electrical connector 38 such that the electrical connector 38 may project from the exterior sidewall 20 through the skirt 26. Thus, in the circumferential direction, the skirt 26 may be interrupted at the position of the electrical connector 38. The skirt 26 does not block or hinder the accessibility of the electrical connector 38.

Furthermore, according to FIG. 6, the skirt 26 extends beyond a bottom surface of the bottom part 12. The distance 37 is the distance between the bottom surface of the bottom part 12 and the mounting surface. Thus, the skirt 26 extends to the mounting surface when the refrigerant gas leak sensor is arranged on the mounting surface. The skirt 26 may therefore provide mechanical stability and support for a user mounting the refrigerant gas leak sensor on the mounting surface.

The distance 37 also indicates the free space below the bottom part 12. A gas flow path passing the skirt 26 may enter the free space below the bottom part 12 and may lead to the channel 18 in a diffusive manner.

The height of the enclosure 10 from the lower edge of the skirt 26 to the top surface of the top part 14 may be in the rage of 10 mm to 40 mm, preferably 15 mm to 30 mm, most preferred 19 mm.

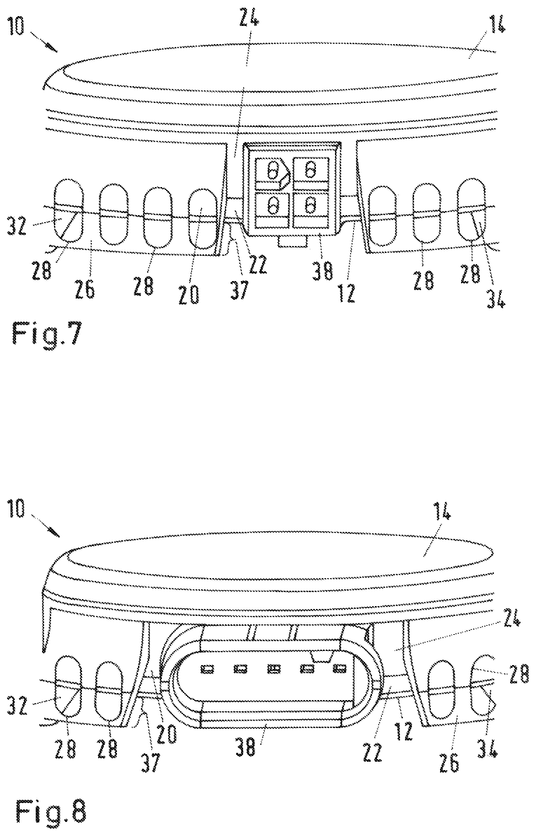

In another example shown in FIG. 7, the electrical connector 38 is a mate and lock connector comprising four pins. The recess or gap of the skirt 26 at the position of the electrical connector 38 in this example is smaller than in the example of FIG. 6.

FIG. 8 shows an even further example of the electrical connector 38. In this example, the electrical connector 38 comprises five pins being arranged along a line in circumferential direction. The recess or gap of the skirt 26 at the position of the electrical connector 38 in this example is bigger than in the example of FIGS. 6 and/or 7.

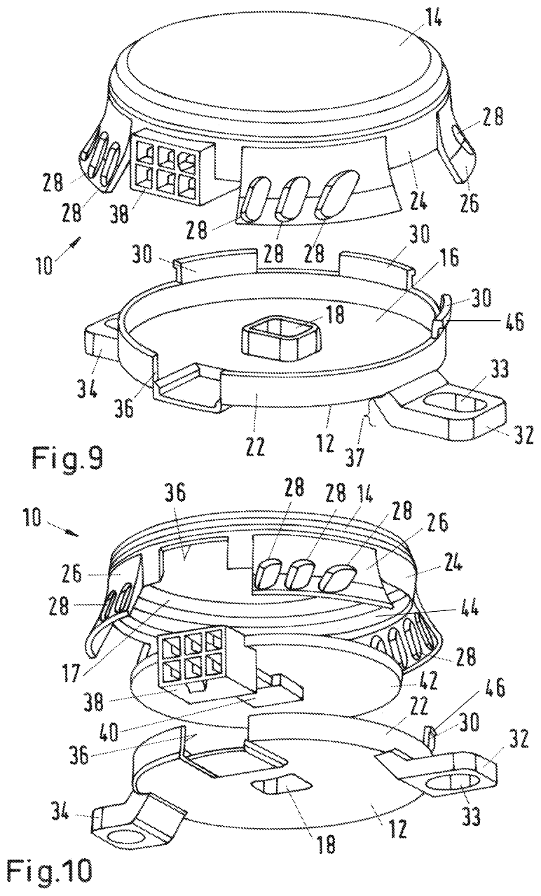

FIG. 9 shows a view before attaching the top part 14 to the bottom part 12. A snap-fit assembly 30 may provide the attachment between the top part 14 and the bottom part 12. The snap-fit assembly 30 may comprise at least one snap-fit 46. The snap-fit 46 may project from the first section 22 of the exterior sidewall along a direction being perpendicular to the circumferential direction. When the top part 14 is attached to the bottom part 12, the snap-fits 46 may project towards the top part 14.

The top part 14 may comprise receptions 44 shown in FIG. 10 for the snap-fits 46 on the inner side of the second section of the exterior sidewall 46. The snap-fits 46 may snap into the reception 44 when pushing the top part 14 onto the bottom part 12. Then, the top part 14 is attached to the bottom part 12 in a form-fit matter.

In another example (not shown), the snap-fits 46 may be arranged on the top part 14, wherein the bottom part 12 may comprise the receptions 44 for the snap-fits 46.

The enclosure 10 may comprise a connector opening 36. The connector opening 36 may be arranged in the first and second section 22, 24 of the exterior sidewall. The electrical connector 38 may be arranged in the connector opening 36. The connector opening 36 extends through the exterior sidewall into the chamber 16. Furthermore, the connector opening 36 is adapted to the electrical connector 38 to be used.

FIG. 10 shows another example of the enclosure 10 being used with another type of electrical connector 38 as in the example of FIG. 9. FIG. 11 shows the refrigerant gas leak sensor of FIG. 10 in another view.

As shown in FIGS. 10 and 11, the second section 24 may also comprise a portion of the connector opening 36. The electrical connector 38 is attached to a printed circuit board assembly 42. The printed circuit board assembly 42 may be arranged in the chamber 16, 17 of the enclosure, wherein the electrical connector 38 is seated in the connector opening 36 of the bottom part 12 and the sensing element 40 closes the channel 18 inside the enclosure 10. Then, the top part 14 may be attached to the bottom part 12 via the snap-fit assembly 30, wherein the electrical connector 38 is seated in the connector opening 36 of the top part 14.

FIG. 12 shows another view of the enclosure 10 according to FIGS. 9, 10 and 11. The reception 44 is shown as a recess extending along the second section 24 of the sidewall at the chamber 17 in the top part 14.

In this example, the printed circuit board assembly 42 has a circular shape which fits into the inner diameter of the exterior sidewall 20.

The invention is not limited to one of the aforementioned embodiments. It can be modified in many ways.

All features and advantages resulting from the claims, the description and the drawing, including constructive details, spatial arrangements and procedural steps, may be essential for the invention both in themselves and in various combinations.

What is claimed is:

1. An enclosure for a refrigerant gas leak sensor for a heating, ventilation and air conditioning system, the enclosure comprising a bottom part for mounting the enclosure on a mounting surface and a top part being attached to the bottom part, the bottom part and the top part enclosing a chamber for receiving a printed circuit board having a sensing element of the refrigerant gas leak sensor, the bottom part having a channel for connecting to the sensing element and being in fluid communication with ambient air, wherein the enclosure has an exterior sidewall extending in a circular manner around the chamber and the channel and extending between the bottom part and the top part.

2. The enclosure as claimed in claim 1, wherein the exterior sidewall has a first section being attached to the bottom part and a second section being attached to the top part.

3. The enclosure as claimed in claim 1, wherein a connection between the exterior sidewall and the top part is rounded.

4. The enclosure as claimed in claim 1, wherein the exterior sidewall comprises at least one skirt having at least one opening being in fluid communication to the channel.

5. The enclosure as claimed in claim 4, wherein the skirt comprises at least one opening that, in a mounted state of the enclosure, is an access opening to a diffusion dominated gas flow path passing the channel outside the bottom part.

6. The enclosure as claimed in claim 1, wherein the channel is arranged in the center of the bottom part.

7. The enclosure as claimed in claim 1, wherein the enclosure comprises a snap-fit assembly attaching the bottom part and the top part.

8. The enclosure as claimed in claim 7, wherein the snap-fit assembly comprises at least one snap-fit attached to the bottom part.

9. The enclosure as claimed in claim 2, wherein the enclosure comprises a snap-fit assembly attaching the bottom part and the top part, wherein the snap-fit assembly comprises at least one snap-fit attached to the bottom part, and wherein the at least one snap-fit projects from the sidewall towards the top part.

10. The enclosure as claimed in claim 1, wherein the bottom part comprises at least one mounting leg having an elongated mounting hole.

11. The enclosure as claimed in claim 1, wherein the enclosure comprises a connector opening for leading through an electrical connector being attachable to a printed circuit board arranged in the chamber.

12. The enclosure as claimed in claim 11, wherein an electrical connector is arranged in the connector opening.

13. The enclosure as claimed in claim 12, wherein the electrical connector comprises 1 to 10 pins, preferably 2 to 8 pins, further preferably 3 to 7 pins, most preferred 4 to 6 pins.

14. The enclosure as claimed in claim 11, wherein the exterior sidewall comprises the connector opening.

15. The enclosure as claimed in claim 1, wherein at least the top part and/or bottom part comprises a UV-resistant material, preferably a UV resistant polymer, a metal-coated polymer, a metal or a ceramic material.

16. The enclosure as claimed in claim 1, wherein the enclosure comprises a printed circuit board assembly with a sensing element of a refrigerant gas leak sensor, the printed circuit board assembly being mounted in the chamber and the sensing element of the refrigerant gas leak sensor being arranged on the channel and closing the channel.

17. The enclosure as claimed in claim 1, wherein the enclosure comprises an Ingress Protection level of at least IP 54 according to IEC 60529.

18. The enclosure as claimed in claim 1, wherein the enclosure is mountable to a flat surface in any vertical, horizontal or inclined orientation.

19. A refrigerant gas leak sensor having a printed circuit board assembly, a sensing element, and the enclosure as claimed in claim 1, wherein the printed circuit board assembly is arranged in the chamber and wherein the sensing element is attached to the printed circuit board assembly and the sensing element is arranged on an entrance of the channel.

20. A heating, ventilation and air conditioning system comprising at least one mounting surface and at least one enclosure as claimed in claim 1 having a printed circuit board assembly with a refrigerant gas leak sensor, wherein the enclosure is mounted on the mounting surface.
